(19) United States
(12) Patent Application Publication
(10) Pub. No.: US 2006/0230198 A1
(43) Pub. Date: Oct. 12, 2006

(54) Data processing circuit, data processing method and image forming apparatus

(75) Inventor: Hidenori Kobayashi, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/095,095

(22) Filed: Mar. 30, 2005

(51) Int. Cl. G06F 13/38

(52) U.S. Cl. 710/62

(57) ABSTRACT

The present invention, when a fraction for a bus width of a storage area is changed, stores a RAM address storing data immediately before or a RAM address for inputting the changed information in an exclusive register, thereby saves the storage area of data. When calculating stored data together, there is no need to always add the high-order address which is a fraction to calculation, so that the processing time is shortened.

### BACKGROUND OF THE INVENTION

1. Field of the Invention

The present invention relates to a data processing circuit for handling data having a data length exceeding the data bus width and an image forming apparatus using the data processing circuit as an image processing circuit.

2. Description of the Related Art

In an image processing circuit of an image forming apparatus such as a digital copier, for input data, using a memory unit preparing and storing corresponding output as an output data group beforehand, the corresponding output is selected from the group. When generating a color output data group, a laser beam is irradiated onto a photoconductor in correspondence to an image signal, and an electrostatic latent image is formed, and a toner image on the photoconductor which is developed by a developing unit is sequentially transferred onto an intermediate transfer belt, thus images are superimposed. Superimposition of color images at this time is color registration.

To obtain scanning information on the intermediate belt, for example, pulse width detection using a counter is often executed.

In a data processing circuit for storing continuous values stepping up or stepping down because the inclination of output values of the counter is fixed to positive or negative in a memory, when storing the output values in the memory, they are generally divided and stored into the data bus width unit of the memory.

Conventionally, as the efficient using or reading time in the memory area is shortened, various proposals are made. For example, a processor retains the preceding high order address when the processor accesses the memory and compares it with the high order address outputted from the processor this time. When a mismatch occurs, among the data in correspondence to the first data bus width of the memory, the most significant data is accessed in the second data bus width of the processor, so that the processor permits access to the memory and writes the low order data excluding the most significant data respectively in the data buffer. The low order data requires no memory access, thus a data confirmation signal can be outputted at least one clock earlier. Shortening the read time by it is disclosed in Japanese Patent Application 04-181451.

Further, high order n+1 bits of A-bit data inputted to a data storage circuit are input to a continuous bit detection circuit and it is checked for whether bits of the same value are continued or not. It is disclosed in Japanese Patent Application 2002-63022 that when bits of the same value are continued in the high order n+1 bits, data stored in an input register is shifted by n bits on the MSB side, and a 1-bit flag indicating the shifting is generated, and the high order Q bits of the shifted data and flag are stored in a RAM.

In the aforementioned conventional example, for example, when a 17-bit counter value is stored whenever a signal inputted from the outside changes, assuming the bus with of a storage element as 16 bits, it cannot be stored at one address, so that it is stored at two addresses. In this case, data of 16 bits×2=32 bits is stored, though the actual data is only 17 bits in length, so that the residual data of 15 bits may be said to be a useless storage area. When the number of data to be stored is small, it is not questionable, though as the number of data to be stored increases, the necessary memory amount increases. It results in enlargement of the circuit and an increase in cost.

Therefore, a data processing circuit for efficiently storing data whose length is longer than the bus width in the memory is desired.

### DESCRIPTION OF THE DRAWINGS

FIG. 1 is a drawing showing the constitution of an example of an image forming apparatus using the data processing circuit relating to the embodiment of the present invention.

FIG. 2 is a block diagram showing the constitution of an example of the data processing circuit relating to the embodiment of the present invention.

FIG. 3 is a waveform diagram of the essential section of the data processing circuit relating to the embodiment of the present invention.

### DETAILED DESCRIPTION OF THE INVENTION

Throughout this description, the embodiments and examples shown should be considered as exemplars, rather than limitations on the apparatus and methods of the present invention.

Hereinafter, one embodiment of the present invention will be explained with reference to the accompanying drawings.

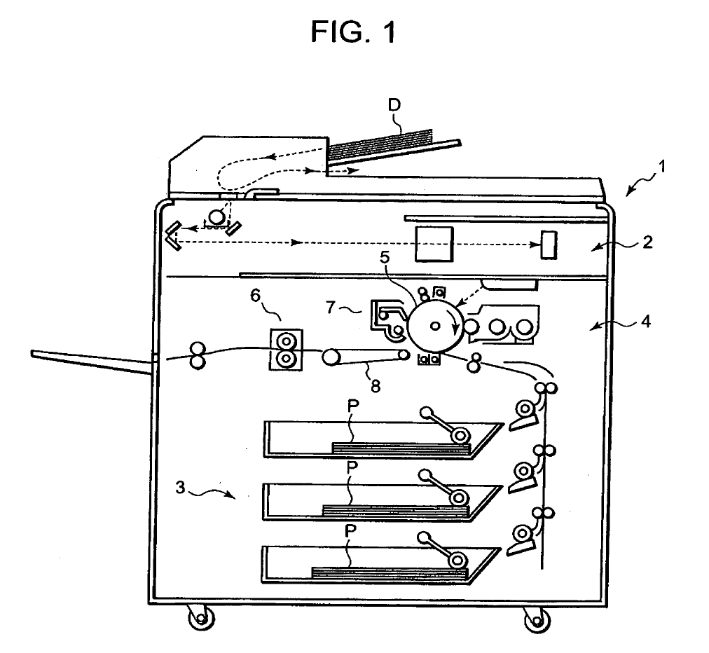

FIG. 1 is a schematic block diagram showing the whole of a color digital copier 1 which is an image forming apparatus using the data processing circuit relating to the embodiment of the present invention. The digital copier 1 includes a scanner 2 for reading an image of a document and obtaining image data, a printer portion 4 which is an image forming unit for forming an image based on the image data obtained by the scanner 2 on a sheet of paper which is a recording medium, and a paper supply device 3 for supplying a sheet of paper P which is a recording medium to the printer portion 4.

The printer portion 4 includes a toner image forming unit 7 for forming a toner image on a photosensitive drum 5 which is an image carrying member, a transfer unit 8 for transferring the toner image formed on the photosensitive drum 5 to the sheet of paper P, and a fixing device 6 for heating, pressurizing, and fixing the toner image of the sheet of paper P.

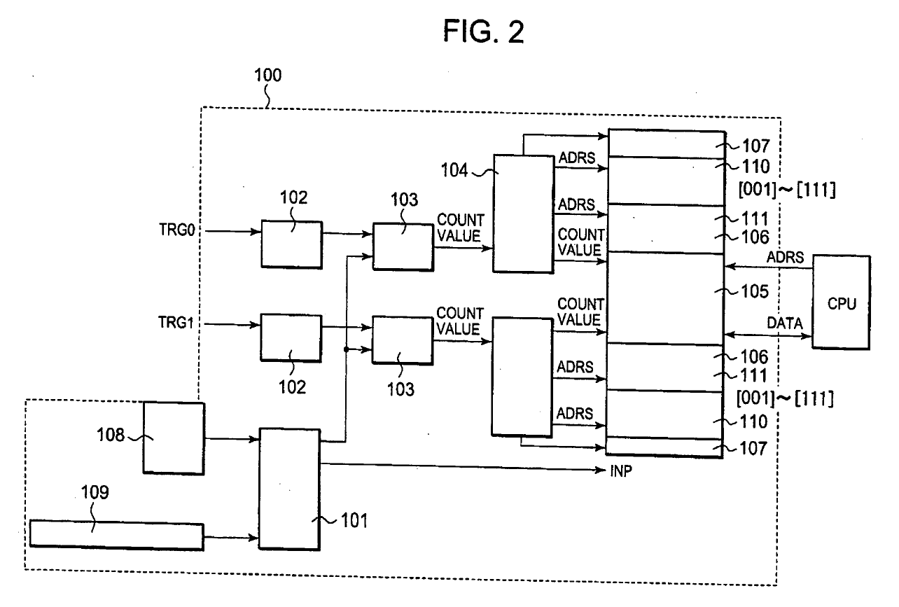

FIG. 2 is a block diagram for explaining the constitution of the signal pulse width detection circuit relating to this embodiment.

In a color digital copier, for example, imaging units of four colors operate in parallel, so that realization of high accuracy of color registration between the colors imaged is essential to improve the image quality. In the imaging units of the respective colors, the respective laser writing units irradiate a laser beam onto the photoconductor in correspondence to an image signal, form an electrostatic latent image, and sequentially transfer a toner image on the photoconductor, which is developed by a developing unit, onto an intermediate transfer belt to superimpose it.

The image superimposed on the intermediate transfer belt by the transfer unit is transferred onto a sheet of paper and is outputted via the fixing step.

The color registration of superimposition of images of various colors includes 1) scan bending control for correcting bending of each scanning line and fitting to similar shapes, 2) horizontal magnification control of the main scanning part for controlling and fitting the density state of the dot positions of a light beam in the main scanning direction, 3) scanning line inclination control for controlling the inclinations of the scanning lines in the sub-scanning direction so as to make them parallel with each other, 4) main scanning writing start timing control for controlling and fitting the displacement of the scanning start position in the main scanning direction, 5) sub-scanning front end timing control for controlling and fitting the writing start position in the sub-scanning direction, and 6) main scanning overall horizontal magnification control for controlling and fitting the displacement of the scanning line width in the main scanning direction.

Among the control objects of the color registration, the scanning line inclination, main scanning writing start timing, sub-scanning front end timing, and main scanning overall horizontal magnification are greatly changed with time. Therefore, the necessary accuracy cannot be maintained only by the initial adjustment.

Therefore, regarding them, it is necessary to periodically detect and correct the color registration.

The color registration reads a color register mark of each color of Y, M, C, and Bk formed on the intermediate transfer belt by a photodiode and detects it as a shift amount between images of various colors. With respect to the color register mark, for example, a line parallel with the main scanning direction and an image in a shape at an angle of 45° with the main scanning direction are formed in two positions at a predetermined distance in the main scanning direction. By the detection time difference in reading the line in this shape and by the detection time difference in reading the two marks arranged away from each other in the main scanning direction, the main scanning writing start timing and the sub-scanning front end timing, main scanning overall magnification, and scanning line inclination are respectively detected as a difference from the Bk mark. The detected time differences are converted to automatic register correction amounts for the four correction objects and are used for correction.

When reading the color register mark, to eliminate the effect of a reading error due to scratches of the surface of the intermediate transfer belt, it is preferable to read it several times.

A data processing circuit 100 shown in FIG. 2 stores scanning information obtained by scanning the transfer belt by an optical scanner and uses it at the time of color registration.

The data processing circuit 100 sends and receives data and address information from a CPU installed outside. The data processing circuit 100 includes a 18-bit counter 101 for fetching and counting data, a noise removal unit 102 for removing noise included in sensor output, an edge detecting unit 103 for detecting the edge of a signal, that is, start-up and shut-down, a RAM controller 104 for executing writing control into the RAM area and register control, a random access memory (RAM) 105 as a memory area, an address register 106 retaining address information, a flag register 107 retaining write information, a basic timer 108 for generating a reference clock, and a pulse width detection period setting unit 109 for setting the sampling period.

The address register 106 is composed of an address register 110 having a 3-bit carry and an address register 111 for storing final data.

In the image forming apparatus, the transfer belt is scanned by the optical sensors arranged on the left and right, though the optical sensors are easily affected by noise due to external light and static electricity, and the sensor output is weak. Therefore, sensor outputs TRG0 and TRG1 are fetched by the noise removal unit 102 and the noise is removed here.

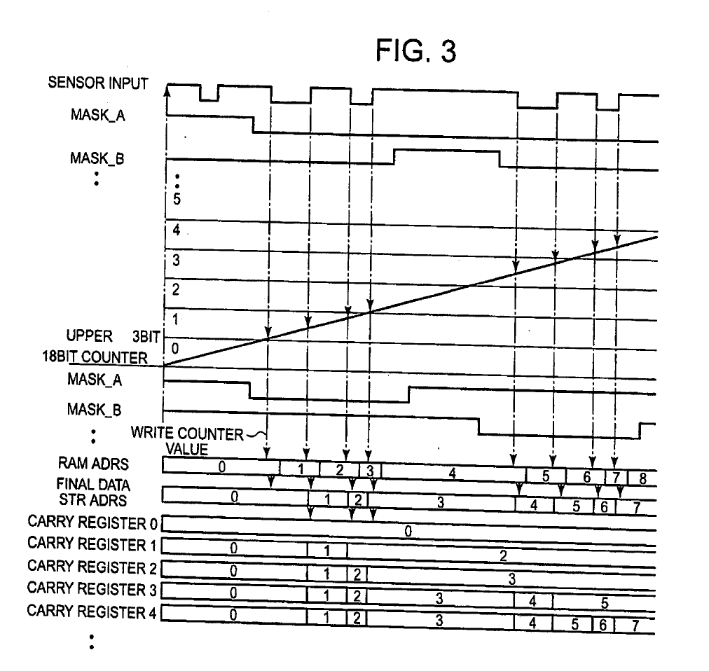

FIG. 3 shows the waveform of each unit of the signal pulse width detection circuit and the outputs from the sensors arranged on the left and right are basically the same, so that only the output of one sensor is displayed. Further, the waveforms of the carry address registers are omitted partially.

The sensor outputs of the waveforms as shown in FIG. 3 are input. The position information of each color register mark is known, so that the changing point of the sensor output under scanning can be expected. Here, noise is generated in the sensor output within the range up to the expected changing point and the signal is disordered from H to L. The MASK A masks the signal when it is high and cancels the noise. Similarly, the drawing shows that the MASK B masks the center of the sensor output waveform when it is high. Further, the noise removal unit can be installed in correspondence to each color.

The sensor output with the noise removed is sent to the edge detecting unit.

To the edge detecting unit, from the 18-bit counter for counting up by the reference clock of the basic timer and setting the sampling period by the pulse width detection period setting unit, count values are supplied. Therefore, the CPU does not need to directly control the 18-bit counter.

The edge detecting unit detects shut-down or start-up of the pulse signal and reads the count value of the 18-bit counter at the time of detection. Further, the edge detecting unit does not need to detect both start-up and shut-down of the pulse signal and needless to say, it may detect one of them.

The count value from the edge detecting unit is sent to the RAM controller.

The RAM controller, into the carry address register, writes the RAM address where data is written every detection of the changing point until the high-order three bits are switched.

Further, the RAM controller stores the low-order 15 bits of the count value in the RAM and adds the logical information of the signal to the high-order bit. The RAM controller, according to changing in the signal, for example, when it detects start up and reads the count value, writes “1” and when it detects shut down and reads the count value, writes “0”.

The RAM controller writes the RAM address, where the final data is written, into the final data storage address register. The reason is to always know the end of the address.

In the flag register, shut down or start up of the pulse signal is detected and a flag for discriminating whether data is written into the RAM or not is written.

When shut down or start up of the pulse signal is detected only once, the address values in the carry address register are all set to “00”.

For example, to discriminate whether the high-order three bits of the counter value stored in the RAM at the address 00h are “001” or “010”, the state is divided by the value of the high-order three bits of the 18-bit counter and whether or not to write data into the RAM in the respective states is discriminated.

The operation of the pulse width detection circuit structured like this will be explained below.

The edge of each signal with noise removed is detected by the edge detection circuit. Next, the value of the 18-bit counter when the edge is detected is read. To the value of the low-order 15 bits of the counter value, an information bit indicating the leading edge or trailing edge is added to the high-order position and data of 16 bits in total is written into the RAM. The address value An of the written RAM is stored in the carry address register and final data storage address register. (Refer to FIG. 3.)

In this embodiment, to express the 18-bit counter value, the carry address register needs to represent data of the high-order three bits. Therefore, there are 8 kinds of 0 to 7 in total and when the high-order three bits are “0”, address values in which data is stored in all the eight registers are stored.

Here, a case that a change occurs in the value of the high-order three bits of the counter output will be considered. For example, when “000” is changed to “001” and the edge of an input signal is detected immediately after changing, to store the address information An+1 when “low-order 15 bits+edge information” are stored in the RAM in the carry address register, the carry address register 0 retains the address value An written immediately before changing of the high-order three bits as it is and for the values of the carry address registers 1 to 7, An+1 is written.

Hereafter, whenever the high-order three bits are changed, the number of updating times of the carry address register for storing addresses is reduced.

When the counter finishes counting of the specified count, an interruption signal INP is outputted, and the CPU recognizes end of the operation of the pulse width detection circuit, to restructure the information of pulse width, reads data from the RAM and registers, reconstructs counter value data, and calculates the pulse width.

According to the constitution of the present invention, the RAM can be used effectively, so that by suppression of the RAM capacity, the apparatus can be miniaturized and reduced in cost.

Further, when processing data before reconstruction of the data instead of after reconstruction, for the calculation free of a carry, the RAM data before construction are processed together, so that the processing can be speeded up.

For example, when the CPU is 16 bits in length, rather than processing respective data having the same high-order three bits in this embodiment by positively adding data of high-order three bits to form 18-bit data, processing as subtraction of data of 15 bits in length together can be speeded up because the number of necessary commands is reduced.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. A data processing circuit for inputting and processing continuous data whose inclination is fixed to positive or negative, comprising:
a storage element for storing processed data,
control means, when a data length of said input data is divided by a data bus width of said storage element and a fraction remains, for dividing said input data into high-order data of said fraction and low-order data of a digit divided by said data bus width,
storage control means for storing said low-order data in said storage element,
first registers prepared in correspondence to a number represented by said high-order data for storing an address value of an area of said storage element storing said low-order data and continuously retaining an address value in which final data while said high-order data matches is stored, and
a second register for storing said address value of said area of said storage element for storing said final data.

2. A data processing circuit according to claim 1, further comprising:
data construction means for reconstructing data to be stored on the basis of said retained data of said first and second registers and said data in said storage element.

3. A data processing circuit according to claim 1, further comprising:
a third register for storing, when said fraction for said data bus width of said storage element is changed, an address in said storage element storing data immediately before or an address in said storage element for inputting said changed information.

4. A data processing circuit according to claim 2, wherein:
said data construction means does not perform calculations after data is reconstructed from said high-order data and said low-order data but for calculations free of an occurrence of a carry, processes together stored data of said storage element before construction.

5. A data processing circuit for inputting and processing continuous data whose inclination is fixed to positive or negative, comprising:
a random access memory (RAM) as a storage area,
a basic timer for generating a reference clock,
a pulse width detection period setting unit for setting a sampling period,
a noise removal unit for fetching pulse data from an outside and removing noise included in said data,
a multi-bit counter for counting fetching of said pulse data in timing of said reference clock during said sampling period set by said pulse width detection period setting unit,
an edge detecting unit for inputting respectively output signals from said noise removal unit and said multi-bit counter, detecting start-up and/or shut-down of said signals, and outputting count values,
an address register for retaining address information for storing final data of said data,
a carry register for retaining the number of carries,
a flag register for detecting any of start up and shut down of said pulse signal and retaining writing information of whether to write data into said RAM or not, and
a RAM writing controller for dividing said counter value inputted from said edge detecting unit by the number of bits of a bus width of said RAM, when there is no remainder, controlling writing said count value into a RAM area, when there is a remainder, controlling writing a quotient into said RAM area, controlling writing said remainder into said carry register, and controlling writing said writing information into said flag register.

6. A data processing circuit according to claim 5, wherein:
said data processing circuit scans a transfer belt in an image forming apparatus by an optical sensor, stores said scanning information, and uses it for color registration.

7. A data processing method for inputting continuous data whose inclination is fixed to positive or negative and storing processed data in a storage element, comprising the steps of:
when a data length of said input-data is divided by a data bus width of said storage element and a fraction remains, dividing said input data into high-order data of said fraction and low-order data of a digit divided by said data bus width,
storing said low-order data in said storage element,
storing an address value of an area of said storage element storing said low-order data in first registers prepared in correspondence to a number represented by said high-order data,
continuously retaining an address value in which final data while said high-order data matches is stored in said registers, and
storing said address value of said area of said storage element for storing said final data in said second register.

8. An image forming apparatus for performing a data process for image information obtained, storing it, and forming an image, comprising:
a scanner section for reading an image of a document and obtaining image data,
a paper supply unit for supplying a recording medium to said image forming unit, and
an image forming unit including, on the basis of said image data obtained by said scanner section, a toner image forming unit for forming a toner image on a photosensitive drum which is an image carrying member, a transfer unit for transferring said toner image formed on said photosensitive drum to said recording medium, and a fixing unit for heating, pressurizing, and fixing said toner image on said recording medium for forming an image on said recording medium, wherein:
said image forming unit, when continuously storing said transfer information in a storage element, on the basis of said information, reconstructs, when a fraction for a bus width of a storage area is changed, data for storing a RAM address storing data immediately before or a RAM address for inputting said changed information in an exclusive register, thereby forms an image.
